(19) United States
(12) Patent Application Publication
(10) Pub. No.: US 2022/0143914 A1
(43) Pub. Date: May 12, 2022

(54) CHARGING SYSTEM AND METHOD FOR FEEDING PROCESSING MATERIAL TO AN EXTRUDER SCREW

(71) Applicant: AIM3D GMBH, Rostock (DE)

(72) Inventors: Vincent MORRISON, Krakow am See (DE); Clemens LIBERWIRTH, Rostock (DE); René ZIELKE, Rostock (DE); Robert RADON, Rostock (DE); Tim WEIDNER, Rostock (DE)

(73) Assignee: AIM3D GMBH, Rostock (DE)

(21) Appl. No.: 17/434,144

(22) PCT Filed: Feb. 12, 2020
(86) PCT No.: PCT/EP2020/053580

§ 371 Date: Aug. 26, 2021

(30) Foreign Application Priority Data
Feb. 28, 2019 (DE) 10 2019 202 699.0
Nov. 6, 2019 (DE) 10 2019 217 113.3

(51) Int. Cl. B29C 64/329; B29C 48/05; B29C 48/25; B29C 48/285

(52) U.S. Cl. CPC B29C 64/329; B29C 48/05; B33Y 30/00; B29C 48/288; B29C 48/286; B29C 48/2528

(57) ABSTRACT

A charging system for feeding processing material to at least one extruder screw including a hopper configured to conduct the processing material along a feed direction to the extruder screw, and a material reservoir for the gravity-driven feeding of the processing material to the hopper. The charging system also includes a feeding device via which processing material recirculated at the hopper against the feed direction by action of the extruder screw can again be conveyed in the direction of the extruder screw together with processing material fed from the material reservoir.

### CROSS-REFERENCE TO RELATED APPLICATIONS

This application is the U.S. National Phase of PCT Application No. PCT/EP2020/053580, filed on Feb. 12, 2020, which claims priority to German Patent Application No. DE 10 2019 202 699.0, filed on Feb. 28, 2019, and to German Patent Application Number DE 10 2019 217 113.3, filed on Nov. 6, 2019, the disclosures of which are hereby incorporated in their entirety by reference herein.

### TECHNICAL FIELD

The proposed solution relates to a charging system for feeding processing material to an extruder screw, in particular an extruder screw for additive manufacturing with metal, ceramic and/or plastic granules for injection molding.

### BACKGROUND

Screw extruders may be used in the series production of components by injection molding and die casting. The extruder screw, injection nozzle, and die mostly are disposed in a horizontal line relative to each other. The filling may include material granules or powder that is effected in the rearmost part of the screw extruder, i.e., the so-called “feed zone.” The material is vertically guided onto the extruder screw via a hopper that sits on a barrel section of the extruder. Due to a sufficiently large cross-section in the hopper, which prevents bridging, the material falls onto the screw driven by gravity and is drawn in by the same. In series production, so-called three-zone screw extruders are used in general, by which the material is drawn in and conveyed to the nozzle. The material is compressed, deaerated and homogenized. Thereafter, a pressure is built up for filling the die.

The feed zone of the screw extruder may have a barrel section in a housing of the screw extruder. A hopper is arranged on this barrel section, via which the material can be fed to the screw. In terms of their minimum cross-section, the barrel section and the hopper are chosen so that bridging of the material granules does not occur. This may depend upon the angle of repose and coefficient of friction of the bulk material used.

### SUMMARY

According to an embodiment, a proposed charging system for feeding processing material to at least one extruder screw, such as a vertically extended extruder screw, includes a hopper configured to conduct the processing material along a feed direction to the extruder screw. The system further includes a material reservoir for the gravity-driven feeding of the processing material to the hopper and a feeding device, via which processing material recirculated or pushed back to the hopper against the feed direction by action of the extruder screw can again be conveyed in the direction of the extruder screw together with processing material fed from the material reservoir.

The proposed charging system allows to again actively convey processing material possibly recirculated from the hopper by action of at least one rotating extruder screw via a feeding device together with processing material originating from the material reservoir in the direction of the at least one extruder screw (and hence possibly also a plurality of extruder screws) and hence via the hopper to the at least one extruder screw. In this way, it is possible to blend (a) the processing material recirculated at the hopper by action of the rotating extruder screw with (b) the processing material fed from the material reservoir. Thus, the feeding device, acting, for example, mechanically, electrically, pneumatically and/or magnetically, is equipped and provided for appropriate blending.

Thus, on the basis of the proposed solution, the extruder screw and hence the extruder apparatus equipped therewith, e.g., a screw extruder, can be filled with returning processing material. Blending of recirculated and possibly already at least partly comminuted processing material with “raw” processing material originating from the material reservoir, which can be realized thereby, leads to a compaction of the processing material fed to the extruder screw. This in turn provides for a more compact design of the extruder screw, which could not be achieved so far in high-speed extrusion applications without negatively influencing the quality of the component to be manufactured.

In one design variant, the charging system is configured for feeding granular processing material to a vertically extended extruder screw. In the properly mounted state of the charging system, processing material hence is thereby fed to a vertically extended extruder screw.

In one design variant, the hopper includes a comminution tool that comminutes least part of the granular processing material entering the hopper as the extruder screw rotates. The comminution tool may prevent the processing material from freewheeling on the extruder screw without being conveyed forward. Instead, by action of the rotating extruder screw at least part of the possibly coarse processing material is comminuted at the comminution tool, whereby the bulk density in the region of the extruder screw is increased. Therefore, in or near a plastification-and-homogenization zone of the extruder screw, less air needs to be pressed out of the processing material. In this connection it can also be provided that within a filling zone of the hopper, the comminution tool forms at least one comminution edge for the comminution of the granular processing material by action of the rotating extruder screw. By action of the rotating extruder screw, granules of the processing material are pressed against the at least one comminution edge and thereby comminuted, e.g., crushed.

The at least one comminution edge can be provided, for example, on a cone-shaped reducing body of the comminution tool, on a wall of the comminution tool extending along the longitudinal hopper axis, or on a wall of the comminution tool at least sectionally extending spirally around the longitudinal hopper axis. The comminution tool may comprise vertically extending ribs or blades within the hopper, which form one or more comminution edges for the comminution of the processing material.

In operation of the extruder screw, comminuted processing material, such as powdery processing material, can be recirculated, e.g., pushed back at the hopper against the feed direction by the comminution tool, so that processing material backed up (comminuted) remains at a filling zone of the hopper. For example, powdery processing material in the form of crushed or pounded granules then are pressed upwards on an inner wall of the hopper and form a wall blocking the inflow of processing material originating from the material reservoir. Thus, a disturbing bridge can be formed in the filling zone of the hopper. In such a design variant, comminuted processing material recirculated in this way can selectively be conveyed to the extruder screw via the feeding device together with the comminuted granular processing material fed from the material reservoir.

For example, the feeding device comprises a longitudinally shiftable slide for mechanically conveying the processing material in the direction of the extruder screw. Alternatively or additionally, the feeding device for conveying the processing material in the direction of the extruder screw can include at least one compressed-air nozzle and/or at least one solenoid coil. The use of a solenoid coil may be advantageous in connection with metallic, granular processing material.

When using a longitudinally shiftable slide as part of the feeding device, it can be provided that the slide has an L-shaped cross-section. Such a cross-sectional shape of the slide has proven to be advantageous in connection with various processing materials, such as for example metal granules for injection molding, wax-filled metal granules for injection molding, fiber-filled granules and unfilled granules.

Alternatively or additionally, one design variant provides that a longitudinally shiftable slide of the feeding device has a ramming portion for conveying the processing material in the direction of the extruder screw, which has an indentation on a front side facing the extruder screw. The indentation provided on the front side, which for example is concave, then for example corresponds with an outer contour of the extruder screw. In one design variant, the bulge is dimensioned such that with a slide longitudinally shifted maximally in the direction of the extruder screw at least part of an outer edge of the extruder screw is present within the indentation of the ramming portion. Via the indentation, the largest possible approach of the slide to the extruder screw hence is possible, without the longitudinally shifted slide impairing the rotatability of the extruder screw. In a longitudinally shifted, i.e. extended state, the slide can be moved up to the extruder screw. At the same time, however, a narrow gap is left between the ramming portion of the slide and the extruder screw, so as not to impede the rotation of the extruder screw.

In one design variant, the slide includes two side walls each extending transversely to an adjustment direction, along which the slide is longitudinally shiftable, and defining a space between themselves. Via the side walls correspondingly facing each other, for example a pocket-shaped space can thus be formed on the slide. In the region of the space, the slide then for example has an L-shaped cross-section and is bordered by the side walls on its long sides. By using the side walls extending transversely to an adjustment direction and an interposed space that is open in the adjustment direction it has been found that certain granular processing materials, such as wax-filled metal granules for injection molding, can be processed easily, as the side walls prevent the processing material from forming bridges of attached processing material on the walls of the hopper and/or a feed zone. For example, when using wax-filled metal granules for injection molding as processing material, a generally L-shaped slide has side walls facing each other to prevent kneaded chunks of wax.

In one design variant, the charging system includes an electronic control unit programmed to adjust a frequency at which the feeding device conveys (returns) processing material in the direction of the extruder screw. For example, the electronic control unit may adjust the frequency of back-and-forth movement of a longitudinally shiftable slide of the feeding device to convey processing material recirculated at the hopper during a forward movement again in the direction of the extruder screw.

The proposed solution may also include an extruder apparatus comprising at least one extruder screw and at least one proposed charging system as well as a 3D printing device including at a charging system according to one or more embodiments of this disclosure.

Another aspect of the proposed solution relates to a method for feeding processing material to an extruder screw, such as for feeding granular processing material to an extruder screw. The method may include processing material originating from a material reservoir is fed to a hopper by action of gravity, via which hopper the processing material is moved to the extruder screw along a feed direction, and processing material displaced in a direction opposite to the feed direction by action of the rotating extruder screw is again conveyed to the extruder screw together with processing material from the material reservoir by a feeding device.

For example, when the comminuted (and at least partly powdery) processing material is pushed out of the hopper in a direction opposite to the feed direction by action of the rotating extruder screw, this processing material originating from the hopper is blended with processing material newly arriving from the material reservoir and is actively conveyed to the extruder screw via the feeding device acting, for example, mechanically, electrically, pneumatically and/or magnetically.

A proposed method can be implemented by using a design variant of a proposed charging system. The advantages and features of design variants of a proposed charging system as explained above and below thus also apply for design variants of a proposed method, and vice versa.

### BRIEF DESCRIPTION OF THE DRAWINGS

The attached Figures by way of example illustrate design variants of the proposed solution.

FIG. 1 shows a first exemplary embodiment of a proposed charging system in a sectional view.

FIG. 2 shows a detail representation of FIG. 1 on an enlarged scale.

FIG. 3 shows another design variant of a proposed charging system.

FIG. 4 shows another design variant of a proposed charging system.

FIG. 5 shows another design variant of a proposed charging system.

FIG. 6 shows another design variant of a proposed charging system.

FIG. 7 shows another design variant of a proposed charging system.

FIG. 8 shows another design variant of a proposed charging system.

FIG. 9 shows a sectional representation of a proposed extruder apparatus comprising a comminution tool.

FIG. 10 shows a top view of the extruder apparatus of FIG. 9.

FIG. 11 shows a detail view of FIG. 9.

FIG. 12 shows another detail view of FIG. 9.

FIG. 13 shows another detail view of FIG. 9 with a granular processing material.

FIG. 14 shows a top view of another design variant of an extruder apparatus comprising an alternatively designed comminution tool.

FIG. 15 shows a cross-sectional view of another exemplary embodiment of an extruder apparatus comprising an alternatively designed comminution tool with a spiral screw.

FIGS. 16A-19B show various views of four different variants for a longitudinally shiftable slide for a feeding device of FIGS. 1, 2 and 9 to 15.

FIGS. 20A-20B sectionally and in a cross-sectional view, show a variant of a feeding device comprising a variant of a slide that is L-shaped at least in a cross-section corresponding to FIGS. 17A-17B and 19A-19B in a retracted state (FIG. 20A) and in a longitudinally shifted, extended state (FIG. 20B).

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

DE 10 2014 018 081 A1 describes a 3D printing device for the additive manufacture of metallic components. There is likewise used a screw extruder that processes processing material in the form of granules. In a traversable printing head of the 3D printing device, the thermoplastically deformable processing material is extruded layer by layer by means of a perpendicularly arranged screw extruder, in order to produce a three-dimensional component. More details concerning the conveyance of the processing material to the extruder screw cannot be found in DE 10 2014 018 081 A1.

The use of screw extruders for additive manufacturing is limited by their weight and overall size, which typically depends on the length of the extruder screw, as the screw extruders either are of traversable design or the entire working field is moved. The latter variant, however, requires to make the entire 3D printing device distinctly oversized.

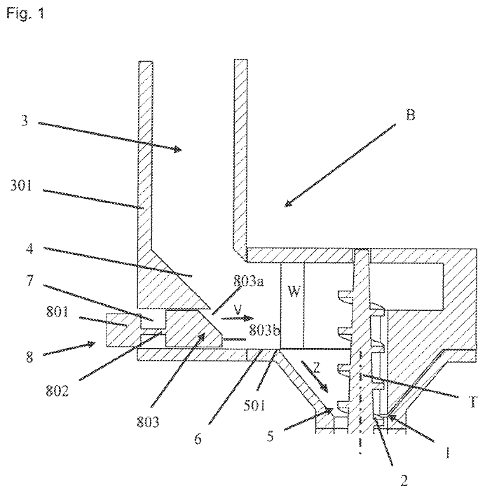

FIG. 1 shows a design variant of a proposed extruder apparatus in the form of a vertical extruder 1. The vertical extruder 1 includes an extruder screw 2 (only the upper region is shown). The extruder 1 is connected to a charging system B configured to feed materials to the extruder screw 2. The charging system may include a material reservoir 3, e.g., a bunker. At its end facing the extruder screw 2, the bunker 3 has a feed ramp 4 that facilities the flow of gravity-feed granular processing material. The feed ramp 4 is a compact unit and has an upper region connected to a bunker wall 301.

A (filling) hopper 5 rests against the extruder screw 2, wherein the granular processing material is conveyed from the feed ramp 4 into the hopper 5 by action of gravity. Between the feed ramp 4 and the hopper 5, there is an opening 80 in the bunker wall 301, wherein the feed ramp 4 represents an upper boundary for the opening 80. An upper edge 501 of the hopper 5 merges into a horizontally extending feed zone 6 which in its length extends to the outer bunker wall 301. This horizontally extending feed zone 6 is the lower boundary for the opening 80.

The opening 80 serves to receive a feeding device 8 and is dimensioned corresponding to the size of the feeding device 8. The feeding device 8 includes a pneumatically, hydraulically, mechanically, or electrically driven lifting cylinder 801, a connecting rod 802 and a slide 803. The slide 803 is guided over the horizontally extending feed zone 6 along an adjustment direction V in the direction of a filling zone of the extruder 1. On its side facing the interior of the extruder, the slide 803 has an inclined surface 803a which follows the angle of the feed ramp 4. This surface 803a merges into a ramming surface 803b which is perpendicular and parallel to the bunker wall 301. The ramming surface 803b is at least as large as to correspond to the size of the granules to be processed.

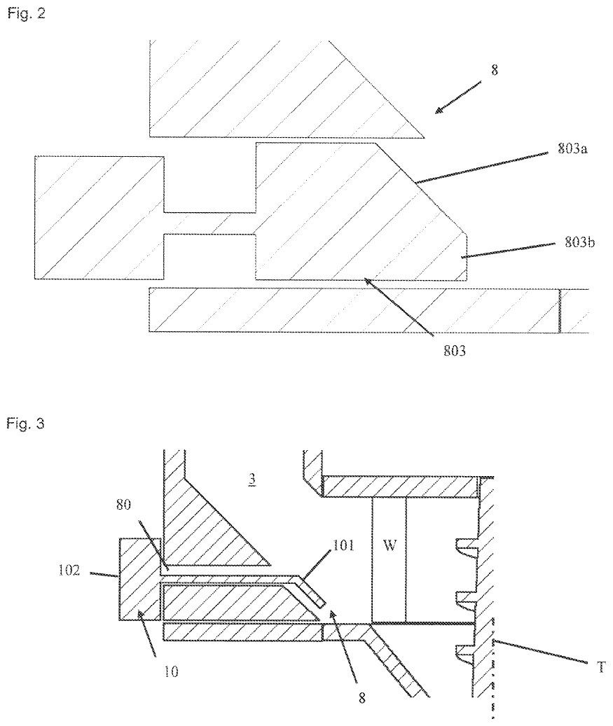

In the case of small-size screw extruders, the granules trickling down can be compacted in connection with the granules pushed back onto the feed ramp 4 and thus form a wall W of powder which prevents new granules from being fed to the extruder screw 2. The feeding device 8 prevents the granules from being pushed back onto the feed ramp 4 on advancement of the slide 803. The stroke of the lifting cylinder 801 is dimensioned such that, in the retracted state, granules can perpendicularly fall out of the bunker 3. Based on the retracted state of the lifting cylinder 801, the stroke length of the cylinder 801 corresponds to the distance between the upper edge 501 of the hopper 5 and the vertical ramming surface 803b of the slide 8 (see FIG. 2). The feeding device 8 pierces blockages located in the way of the wall W, and granules trickling down are actively conveyed into the hopper 5.

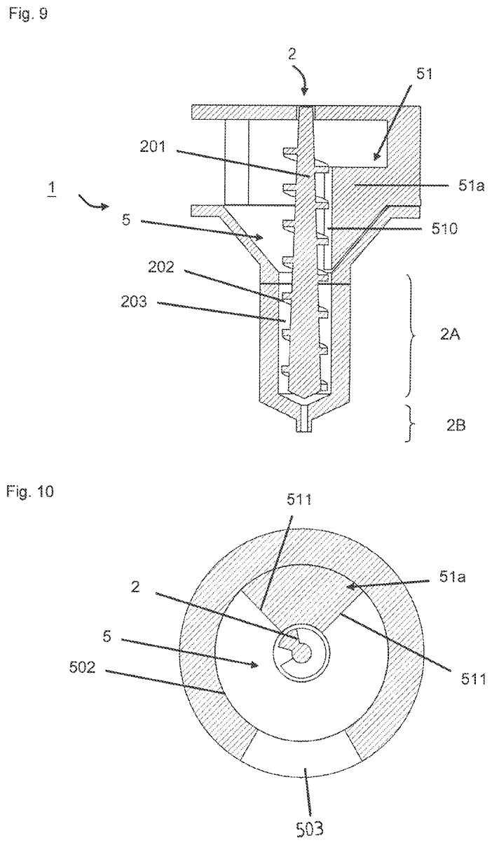

Thus, in operation of the extruder 1, the feeding device 8 conveys the processing material recirculated at the hopper 5 by action of the extruder screw 2 against a feed direction Z together with processing material trickling down from the bunker 3 in the direction of the extruder screw 2. At the hopper 5, processing material recirculated by action of the rotating extruder screw 2 is blended with processing material additionally fed from the bunker 3. Via the feeding device 8, processing material comminuted already by a comminution tool 51 within the hopper 5 (see FIGS. 9 to 15), which is recirculated at the hopper 5 against the feed direction Z (in opposite to direction Z) by action of the extruder screw 2, can be conveyed to the extruder screw 2 together with non-comminuted granular processing material fed from the bunker 3. This requires a lower compaction of the processing material by the extruder screw 2, and the extruder screw 2 can be designed shorter.

FIG. 3 shows another exemplary embodiment. In FIG. 3, all identical components are designated with the same reference numerals as in FIGS. 1 and 2. Here as well, the bunker 3 is provided with a feed ramp 4 at its end facing the extruder screw 2. In the lower region of the feed ramp 4, the opening 80 again is provided, in which a stirring hook 10 as part of a feeding device 8 is mounted as a rotating element. The stirring hook 10 has an electric drive 102 outside the bunker wall 301 and a hook 101 inside the bunker 3, which in its curvature follows the inclination of the feed ramp 4. The length of the stirring hook 10 is dimensioned such that the hook 101 protrudes into the zone that is critical for the formation of a wall W of recirculated processing material and clears the same and hence likewise ensures blending of processing material recirculated from the hopper 5 with processing material trickling down from the bunker 3.

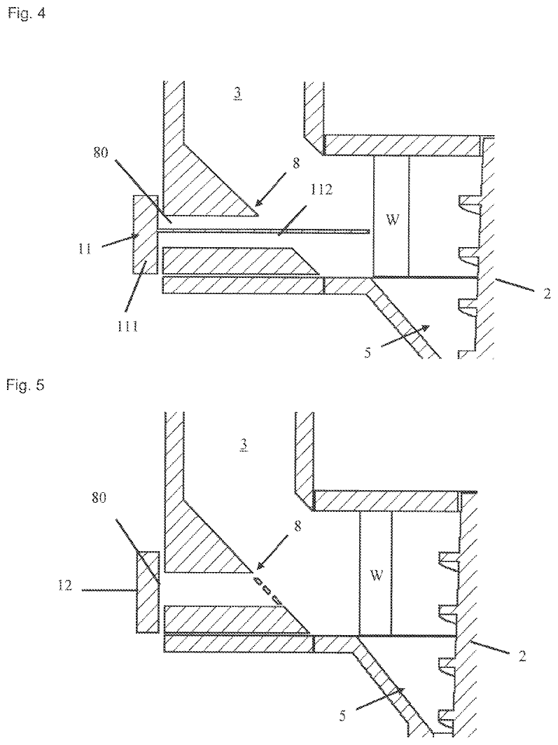

FIG. 4 shows another exemplary embodiment with a bunker 3 including a feed ramp 4 and an opening 80 in which a vibration element 11 is incorporated as part of a feeding device 8. An excitation unit 111, such as a vibration motor, puts a spring element 112 connected thereto into vibrations. The spring element 112 is centrally introduced into the shaft through an opening 80 in the feed ramp 4, possibly only when required (so that the spring element 112, for example controlled by an electric motor, is extended at the opening 80 e.g., at points in time to be defined during the extrusion process). The length of the spring element 112 is chosen such that it protrudes into the zone critical for the formation of a wall W. In this way, the spring element 112 can be located centrally in the fill and loosen or break up a wall W produced or about to be produced by excited vibrations. Furthermore, processing material recirculated from the hopper 5 can thereby be blended with processing material fed from the bunker 3 by means of the vibrating spring element 112.

The exemplary embodiment of FIG. 5 provides a compressed-air nozzle 12 as part of a feeding device 8, via which an air flow can be generated in the direction of the hopper 5. The air flow is guided through the feed ramp 4 through a shaft-shaped opening 80 in a side wall of the feed ramp 4, which is covered with a grating. The grating is designed such that the mesh width or pore size is smaller than the size of the granules to be processed. A permanent air flow prevents the penetration of finely ground powder. The nozzle 12 provides short, powerful air pulses directed towards the wall W to prevent, and if necessary, breakdown the wall W. At the same time, the blending already mentioned above is achieved here as well via the air flow, such as via the additional air pulses.

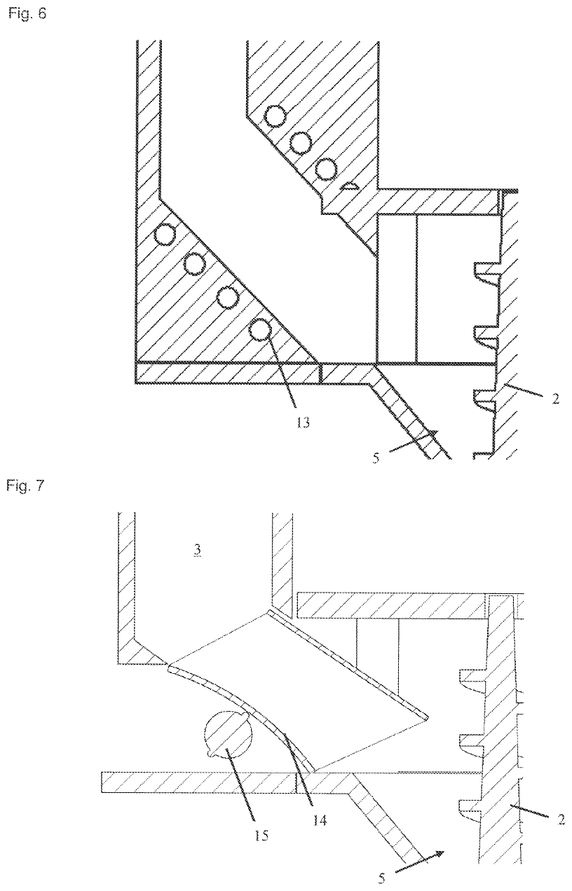

FIG. 6 shows another exemplary embodiment of a charging system B having an electromagnetic coil or solenoid coil 13 in the bunker wall 301 and the feed ramp 4. The coil 13 produces an electric field that, in addition to gravity, applies another force component in the direction of the hopper 5 to the granules trickling down. In this way, a sufficiently large force is exerted on a wall W produced or about to be produced, in order to let the same collapse. This variant requires processing of magnetic or magnetizable processing material, but in this connection can likewise be used for the blending mentioned above, so that the solenoid coil 13 likewise can be part of a feeding device 8.

FIG. 7 shows another exemplary embodiment that includes a transition region between the bunker 3 and the hopper 5. The transition region may include a flexible tube defining a feed ramp 14 that is elastically deformable from outside via a rotatable drive member 15. Due to the alternating tapering and widening of the tube cross-section, granules are induced to trick down into the area of the wall W where the aforementioned blending can be supported.

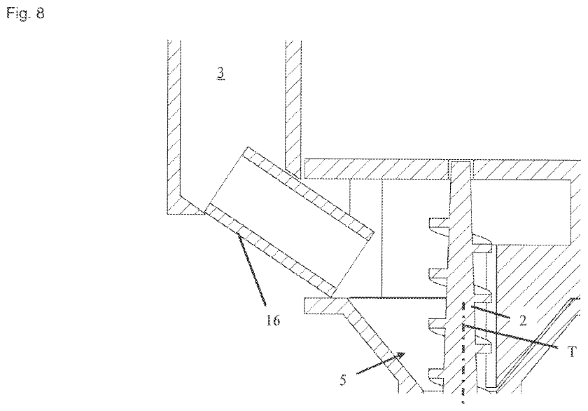

The design variant of FIG. 8 provides a rotating tube 16 driven from outside as part of a feeding device 8. Due to the constant, and possibly oscillating or vibrating movement of the tube 16, the trickling down of granules from the bunker 3 is supported in such a way that the formation of walls W is inhibited thereby, and processing material additionally recirculated from the hopper 5 possibly by the rotating extruder screw 2—together with processing material fed from the bunker 3—is blended and again conveyed in the direction of the hopper 5.

FIG. 9 shows a proposed charging system B in combination with a comminution tool 51 in the hopper 5. There is again shown a vertical screw extruder 1 with its extruder screw 2. The screw extruder 1 is connected to the charging system B. At its end facing the extruder screw 2, the charging system B is connected to a hopper 5 which rests against the extruder screw 2 directly and coaxially to the same, wherein the processing material present in the form of granules G is conveyed into the filling hopper 5 by the charging system B. A small overall height and a reduction of the length/diameter ratio of the screw extruder 1 are supported by the comminution tool 51. The comminution tool 51 is stationarily or movably arranged radially in the feed zone of the screw extruder 1, such as in the filling hopper 5, as is illustrated in detail by way of example with reference to design variants of FIGS. 9 to 15.

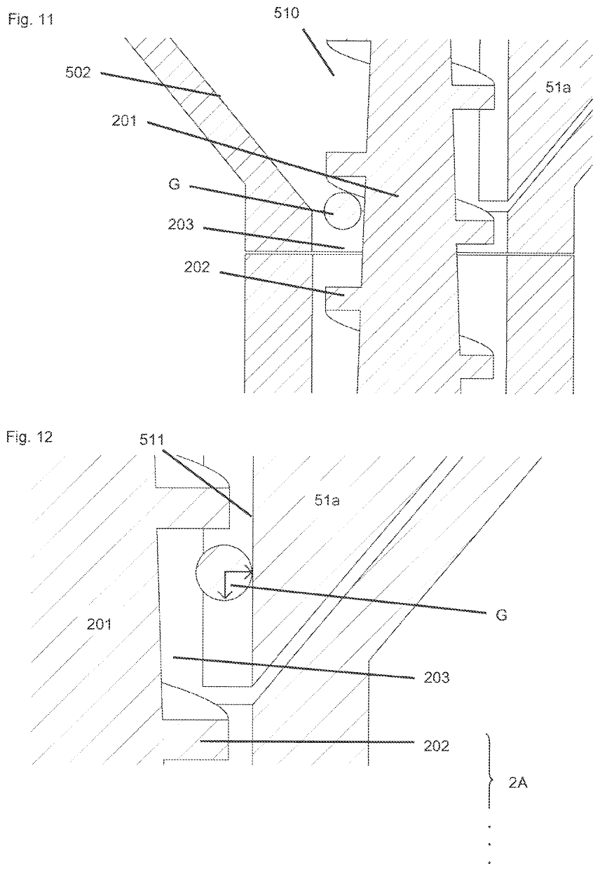

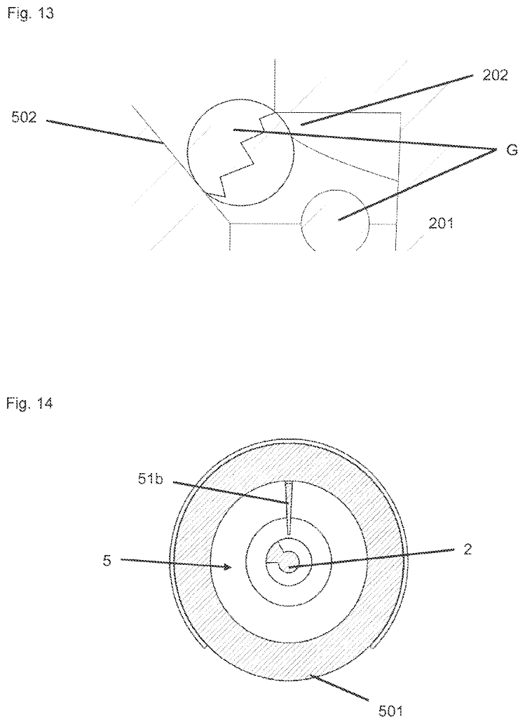

The design variant shown in FIGS. 9 to 13 includes a partial circular section of a cone-shaped reducing body 51a as a comminution tool, which is arranged radially opposite the charging system B and is releasably connected to the (filling) hopper 5. By the cone-shaped reducing body 51a a filling zone 502 in the filling hopper 5 is reduced at this point to such an extent that the extruder screw 2 has a ratio of outer radius to core radius which corresponds to only 1.0 to 1.5 times the diameter of the granular processing material to be conveyed (see FIG. 11). The incoming granular material G falls into the filling hopper 5 and is moved on by the extruder screw 2. The radial arrangement of the cone-shaped reducing body 51a in the filling hopper 5 on the one hand prevents the supplied processing material at the edge of the extruder screw 2 only moves in circumferential direction, i.e., only with the rotation of the extruder screw 2, and is not conveyed downwards. As soon as grains of the granular processing material present at the edge of the extruder screw 2 hit the cone-shaped reducing body 51a, the blocking of the movement in circumferential direction causes a movement in an axial direction (FIG. 12). Since the space between screw shaft 201 and screw blade 202 at the same time is very small, the processing material cannot be moved on as a whole and is crushed at a comminution edge 511 of the cone-shaped reducing body 51a (FIG. 13). The screw shaft 201 and the cone-shaped reducing body 51a are fabricated from a suitable material with respect to the processing material to be processed. The hardness of the screw shaft 201 and the cone-shaped reducing body 51a for example should be greater than or equal to the hardness of the processing material to be processed.

The crushing of the processing material results in an accumulation of fine dust in the filling hopper 5. This dust sliding down fills the space that is obtained due to the bulk density of the coarse processing material in the screw flight 203. In this way, compaction and homogenization of the processing material to be conveyed already takes place during feeding, without thermal action. As less air, too, is conveyed downwards in the extruder 1, the processing material can be melted faster in a succeeding compression zone 2A. The compression zone 2A and a discharge zone 2B succeeding along a longitudinal hopper axis T are distinctly shortened so that the extruder 1 becomes distinctly more compact and a length-diameter ratio of 1:10 to 1:3 can be achieved.

FIG. 14 shows another exemplary embodiment. In FIG. 14, all identical parts are designated with the same reference numerals as in the preceding figures.

As a comminution tool 51, the variant shown in FIG. 14 comprises a vertically extending wall 51b which is arranged radially opposite the charging system B, similar to the cone-shaped reducing body 51a. The vertically extending wall 51b works in a similar way as the cone-shaped reducing body 51a and, by action of the rotating extruder screw 2, provides for a comminution of granules G of the processing material present in the hopper 5 at a comminution edge 511 formed by the wall 51b.

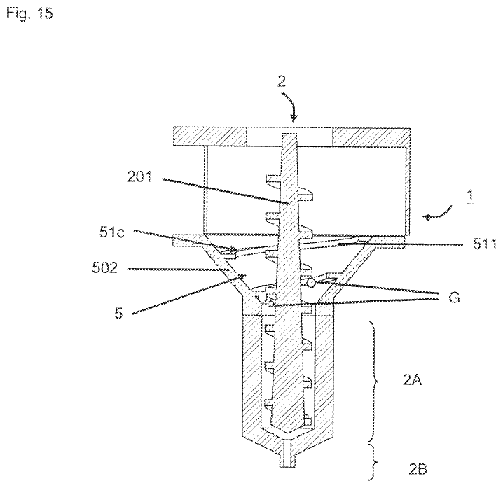

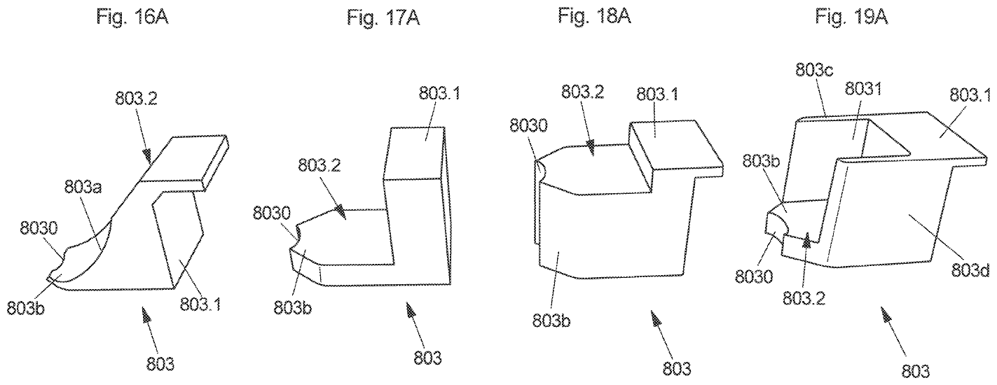

FIG. 15 shows another exemplary embodiment in which the comminution tool 51 includes a counter-rotating spiral screw 51c arranged on the inner wall 502 of the filling hopper 5. Due to the counter-rotation of the spiral screw 51c relative to the screw shaft 201, the granular processing material is transported into the extruder screw 2, compacted and comminuted, whereby a further compaction of the material can take place.

A comminution tool 51 in principle can include at least one stationary element forming at least one comminution edge 511 and/or at least one rotating element forming at least one comminution edge 511. Alternatively or additionally, on an inner wall 502 of the hopper 5 ribs or blades in principle can be releasably, movably and/or immovably arranged, which in the same way act on the granular processing material via at least one comminution edge 511 by action of the rotating extruder screw 2, like the cone-shaped reducing body 51a or the vertically extending wall 51b.

In the present case, each comminution tool 51 of FIGS. 9 to 15 in a charging system B can be combined with a feeding device 8 of the design variants explained above, so that processing material comminuted by the respective comminution tool 51, which is recirculated at the hopper 5 against the feed direction Z by action of the extruder screw 2, can selectively be blended with non-comminuted granular processing material fed from the bunker 3 and can be conveyed to the extruder screw 2 by the feeding device 8.

The proposed extruder apparatus in the form of the extruder 1 works over a large speed range of the extruder screw 2. As a result, it can also be used with processing materials requiring a slow screw speed. The temperature in the feed zone of the extruder screw 2 likewise is dependent on the processing material. Brittle processing materials, such as composite materials, need to be comminuted in a solid state. Tough processing materials, such as pure thermoplastic materials, need a temperature in the vicinity of their respective glass transition temperature. Regardless of the processing material used, the processing material comminuted already, and hence e.g., powdery processing material, together with granular processing material fed to the bunker 3 can again be conveyed in the direction of the extruder screw 2 by the feeding device 8 by action of the extruder screw 2 against the feed direction Z. This permits a significant compaction of the processing material supplied to the extruder screw 2, which in turn allows a more compact design of the extruder screw 2, without having to compromise on the quality of the component to be manufactured.

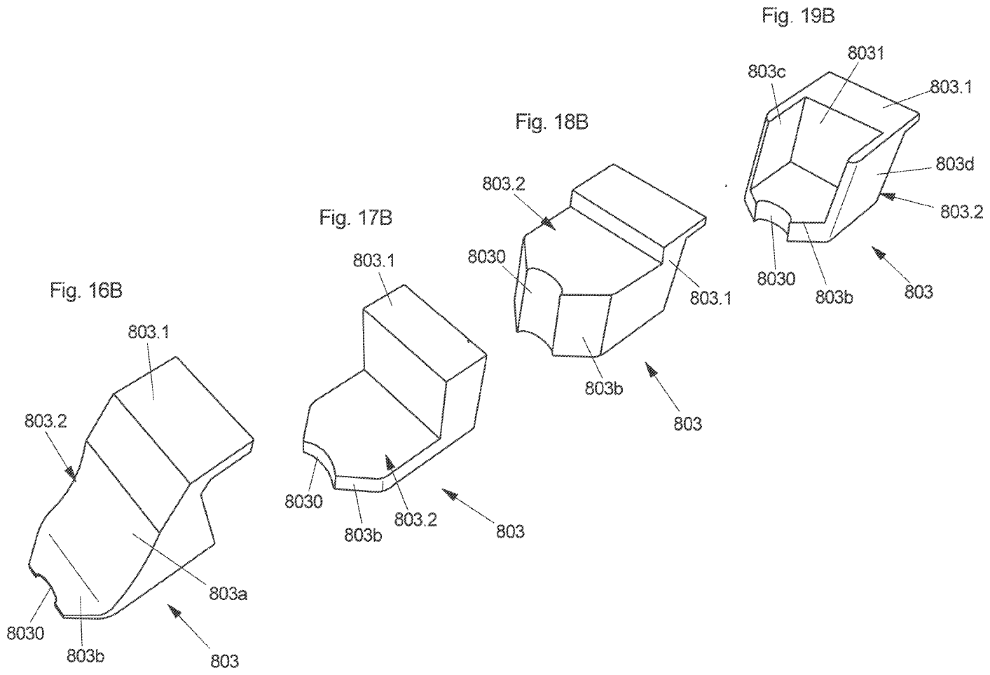

FIGS. 16A-16B, 17A-17B, 18A-18B and 19A-19B show various views of four different exemplary design variants for a longitudinally shiftable slide 803 for a feeding device 8.

The individual variants of FIGS. 16A to 19B differ with regard to their geometry, however, each of the slides 803 of FIGS. 16A to 19B may have a generally L-shaped cross-section, at least in a central portion. The slide 803 may include a connecting body 803.1, to which an adjusting force for adjusting the respective slide 803 is applied along a longitudinal axis, as well as a ramming portion 803.2 adjoining the connecting body 803.1 and projecting in the direction of the extruder screw 2 (when the respective slide 803 is properly mounted in the feeding device 8). On a front side of a ramming portion 803.2, an indentation 8030 is provided, which permits that the respective slide 803 is maximally moved towards the extruder screw 2 when the respective slide 803 is in a longitudinally shifted, extended state. In this extended state, a narrow gap is left towards the top so as not to impair the rotation of the extruder screw 2 also in the extended state of the respective slide 803. The indentation 8030 here can be a negative of the diameter of the extruder screw 2.

The width of each slide 803 of FIGS. 16A to 19B is adapted to the width of a cutout 503 for the slide 803 provided in the region of the upper edge 501 of the hopper 5 so that the slide 803, when in its extended state, fills the cutout 503 present between a bunker opening and the extruder screw 2. This may prevent any abrasion of the processing material from getting behind the slide 803 (see also FIG. 10 for the position of the cutout 503).

In the design variant of FIGS. 16A and 16B, the slide 803 has an inclined surface 803a at its ramming portion 803.2—in so far as in accordance with the design variant of FIGS. 1 and 2. The inclined surface 803a may recirculate the processing material in the direction of the extruder screw 2 and then, via the front-side ramming surface 803b (here provided with the indentation 8030), back into the hopper 5.

In the design variant of FIGS. 17A and 17B, the slide 803 is of L-shaped design. In this design variant, the slide 803 hence includes a disk-like ramming portion 803.2 extending substantially perpendicularly to the connecting body 803.1, which on its narrow front side forms the ramp surface 803b.

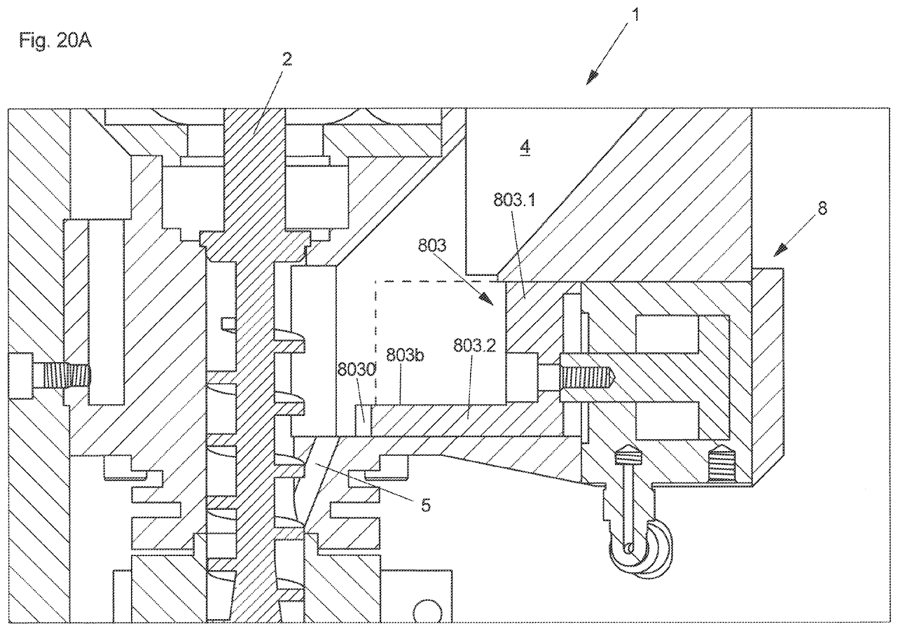

In the design variant of FIGS. 18A and 18B, on the other hand, the ramming portion 803.2 is drawn higher and hence of cube-shaped, possibly cubic design. Thus, the front-side ramming surface 803b provided with the indentation 8030 on the one hand is many times larger than in the L-shaped slide 803 of FIGS. 17A and 17B. Furthermore, the ramming surface 803b extends over a large part of the total height of the slide 803 and substantially perpendicularly to the adjustment direction V, along which the slide 803 in the properly mounted state can be longitudinally shifted in the direction of the extruder screw 2 and away from the same.

In the design variant of FIGS. 19A and 19B, the slide 803 is provided with an L-shaped cross-section at least in a middle region. On the long sides of the slide 803 of FIGS. 19A and 19B, however, in contrast to the design variant of FIGS. 17A and 17B, there are formed mutually opposite side walls 803c and 803d each extending parallel and transversely to the adjustment direction V. Via the mutually opposite side walls 803c and 803b, a pocket-shaped space 8031 is formed on the slide 803 of FIGS. 19A and 19B. This pocket-shaped space 8031 is open towards the extruder screw 2 and towards the top, when the slide 803 of FIGS. 19A to 19B is properly mounted to the feeding device 8. The pocket-shaped space 8031 hence is bordered by inner surfaces of the side walls 803c and 803b facing each other, by a rear wall of the connecting body 803.1 and by an upper side of the ramming portion 803.2. A front-side region of the ramming portion 803.2 with the ramming surface 803b at least slightly protrudes from the side walls 803c and 803d.

All of the illustrated design variants of a slide 803 corresponding to FIGS. 16A to 19B have proven useful for processing various processing materials, such as for example metal granules for injection molding, fiber-filled granules or filled granules. With regard to soft metal granules for injection molding, such as wax-filled metal granules, it has been found, for example, that the side walls 803c and 803d of the design variant of FIGS. 19A and 19B prevent kneaded chunks of wax from attaching to walls of the hopper 5 and the feed zone 6.

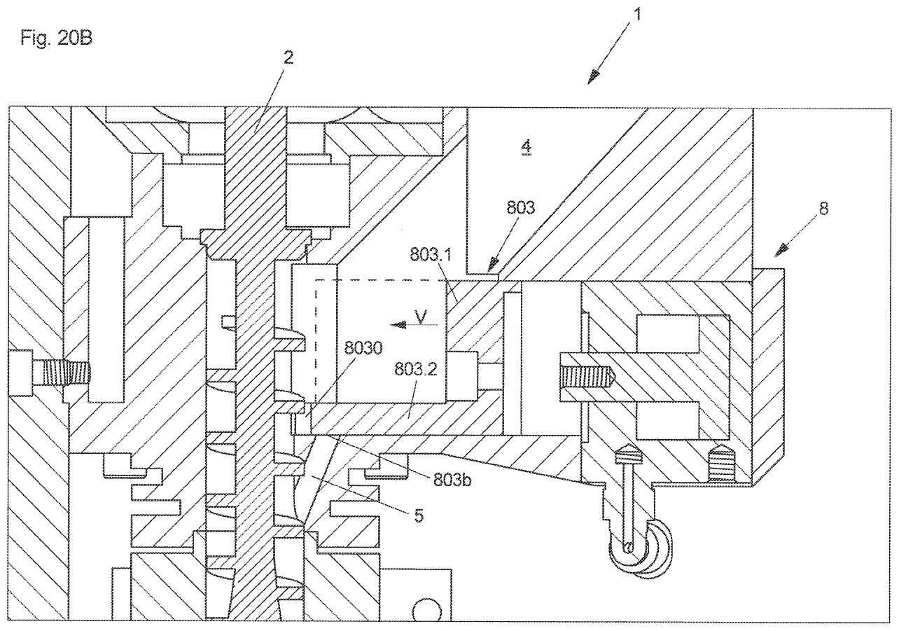

FIGS. 20A and 20B are a sectional view and partially show the use of a slide 803 of FIGS. 17A-17B and (with side walls 803c shown in broken lines) of FIGS. 19A-19B in the feeding device 8. FIG. 20A shows the slide 803 in a retracted state, and FIG. 20B illustrates the slide 803 in a longitudinally shifted and extended state. FIG. 20B illustrates the maximum retraction of the slide 803 up to the extruder screw 2, which can be achieved by the indentation 8030 on the front-side ramming surface 803b. Thread portions of the extruder screw 2 are rotatable at least with an edge-side area partly within the indentation 8030, when the slide 803 is maximally extended along the adjustment direction V in order to again convey recirculated processing material into the hopper 5.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMERALS

1 extruder

10 stirring hook

101 hook

102 handle

11 vibration device

111 excitation unit

112 push rod

12 compressed-air nozzle

13 solenoid coil

14 flexible tube with feed ramp

15 drive member

16 rotating tube

2 extruder screw

201 screw shaft

202 screw blade

203 screw flight

2A compression zone

2B discharge zone

3 bunker (material reservoir)

301 bunker wall

4 feed ramp

5 hopper

501 upper edge of hopper

502 inner wall

503 cutout

51 comminution tool

510 filling zone

511 communication edge

51a (con-shaped) reducing body

51b vertically extending wall

51c spirally extending wall/spiral screw

6 horizontally extending feed zone

7 opening

8 feeding device

80 opening

801 lifting cylinder

802 connecting rod

803 slide

803.1 connecting body (with rear wall or inclined surface)

803.2 ramming portion

8030 indentation

8031 space

803a inclined surface

803b ramming surface

803c, 803d side wall

B charging system

G granules

T hopper axis

V adjustment direction

W wall

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A charging system for feeding processing material to at least one extruder screw, comprising:
a hopper configured to conduct the processing material along a feed direction to the extruder screw;
a material reservoir for gravity-driven feeding of the processing material to the hopper, and
a feeding device via which a portion of the processing material is recirculated at the hopper against the feed direction by action of the extruder screw so that the portion of the processing material is again conveyed in the direction of the extruder screw together with a fresh portion of the processing material fed from the material reservoir.

2. The charging system according to claim 1, wherein the feeding device is configured to blend the portion and the fresh portion by rotation of the extruder screw.

3. The charging system according to claim 1, wherein the processing material is granular, and the extruder screw is vertically oriented, and wherein the charging system is configured to feed the granular processing material to the vertically extended extruder screw.

4. The charging system according to claim 3, wherein the hopper includes a comminution tool configured to comminute the granular processing material entering the hopper as the extruder screw rotates.

5. The charging system according to claim 4, wherein the hopper includes a filling zone, and the comminution tool has at least one comminution edge within the filling zone, wherein the comminution edge is configured to comminute the granular processing material by action of the rotating extruder screw.

6. The charging system according to claim 5, wherein the comminution tool includes a cone-shaped reducing body defining the least one comminution edge on a wall of the comminution tool, wherein the comminution edge extends along a longitudinal hopper axis or the comminution edge extends spirally around the longitudinal hopper axis.

7. The charging system according to claim 4, wherein, during operation, at least some of the processing material is comminuted by the feeding device, is recirculated at the hopper against the feed direction by the extruder screw, and is combined with non-comminuted granular processing material for conveyance in the feed direction by the extruder screw.

8. The charging system according to claim 1, wherein the feeding device includes a longitudinally shiftable slide configured to convey the processing material toward the extruder screw.

9. The charging system according to claim 8, wherein the slide has an L-shaped cross-section.

10. The charging system according to claim 8, wherein the slide has a ramming portion configured to convey the processing material toward the extruder screw, wherein the ramming portion defines an indentation on a front side that faces the extruder screw.

11. The charging system according to claim 8, wherein the slide has two side walls defining a space therebetween, and each of the side walls extends transversely to an adjustment direction, along which the slide is longitudinally shiftable.

12. The charging system according to claim 1, wherein the feeding device includes at least one compressed-air nozzle or at least one solenoid coil

13-14. (canceled)

15. A method for feeding processing material to an extruder screw, comprising:
gravity feeding a processing material originating from a material reservoir to a hopper, wherein the processing material is moved, via the hopper, to the extruder screw along a feed direction;
displacing the processing material, already moved to the extruder screw, in a direction opposite to the feed direction by action of the rotating extruder screw is again to combine with fresh processing material from the material reservoir; and
reconveying the combined fresh and already moved processing material to the extruder screw.

16. The method of claim 15 further comprising:
extending a slide to urge the processing material toward the extruder screw.

17. The method of claim 15 further comprising:
blowing compressed air towards the hopper to urge the processing material toward the extruder screw.

18. A 3D printing device comprising:
at least one charging system including:
a hopper configured to conduct processing material along a feed direction to an extruder screw,
a material reservoir for gravity-driven feeding of the processing material to the hopper, and
a feeding device via which a portion of the processing material is recirculated at the hopper against the feed direction by action of the extruder screw so that the portion of the processing material is again conveyed in the direction of the extruder screw together with a fresh portion of the processing material fed from the material reservoir.

19. The 3D printing device of claim 18, wherein the feeding device is configured to blend the portion and the fresh portion by rotation of the extruder screw.

20. The 3D printing device of claim 18, wherein the hopper includes a comminution tool configured to comminute the processing material entering the hopper as the extruder screw rotates.
